(19) United States
(12) Patent Application Publication
(10) Pub. No.: US 2015/0041605 A1
(43) Pub. Date: Feb. 12, 2015

(54) CLAMPING DEVICE

(71) Applicant: Kwang Wook Nam, Gyeongsangbuk-do (KR)

(72) Inventor: Kwang Wook Nam, Gyeongsangbuk-do (KR)

(21) Appl. No.: 14/385,535

(22) PCT Filed: May 1, 2013
(86) PCT No.: PCT/KR2013/003776

§ 371 Date: Sep. 16, 2014

(30) Foreign Application Priority Data
May 1, 2012 (KR) 10-2012-0045970

(51) Int. Cl. F16M 11/04; F16M 13/02

(52) U.S. Cl. CPC F16M 11/041; F16M 13/022
USPC 248/316.5

(57) ABSTRACT

The present invention relates to a clamping device. According to the present invention, a clamping unit fixing a target object can be operated by the foot or knee using an operation unit, the clamping unit can be redirected to the left and right and upward and downward and can be rotated horizontally, and a support unit supporting the clamping unit can be easily folded and unfolded. Accordingly, the present invention can be conveniently used in the event a disabled person fixes an object by moving the foot or knee thereof, and carves or paints the object. The work using the foot or knee can be rendered convenient in the event many manual operations are required even for non-disabled persons. Also, the clamping device according to the present invention can facilitate the adjustment of the length of the support unit according to the environment of the user.

### TECHNICAL FIELD

The present invention relates to a clamping device, and more particularly, to a clamping device with which it is possible to operate a clamping section that fixes a target object with user's foot or knee, to redirect the clamping section in all directions and horizontally rotate the clamping section, and to easily fold and unfold support sections that support clamping section.

### BACKGROUND ART

People fix a target object, and manually work in their daily life in most cases. In such a case, a clamping device is typically used to fix the target object. When the clamping device in the related art fixes or unfixes the target object, it is necessary to turn a lever several times. At this time, there is a problem in that the clamping device is heavy.

In order to solve the problem, a technology of fixing a device such as a hand clamp to a tripod is disclosed in U.S. Patent Publication No. 2010-0264281. Specifically, this literature describes a configuration capable of flexibly manufacturing three legs of the tripod, and also describes that the three legs having such a configuration are attached to various structures.

However, the structure described in this literature needs to operate the clamping device with user's hand in order to fix the target object. Accordingly, there is a problem in that it is difficult for a handicapped person with a disabled hand to use the device. Even when a user other than the handicapped person works with his or her hand, it is difficult to use the clamping device.

### DISCLOSURE

### Technical Problem

An object of the present invention is to provide a clamping device capable of being operated with user's foot or knee for convenient use when a handicapped person with a disabled hand or a user mostly works with his or her hand.

Another object of the present invention is to provide a clamping device capable of easily redirecting a clamping section in all directions and horizontally rotating the clamping section.

Still another object of the present invention is to provide a clamping device capable of automatically adjust lengths of support sections that support the clamping section.

### Technical Solution

In order to achieve the above objects, an exemplary embodiment of the present invention provides a clamping device including a clamping section, a connection section, and an operation section. The clamping section includes a fixing part configured to a target object, and a holding part configured to operate the fixing part. The connection section is connected to the clamping section to extend downward. The operation section is coupled to a lower end of the connection section to operate the clamping section. A user operates the operation section with his or her foot to operate the clamping section.

The clamping section according to the embodiment of the present invention may further include an adjustment section. The adjustment section may be coupled to a lower portion of the clamping section, and adjust a position of the clamping section.

The adjustment section of the clamping device according to the embodiment of the present invention may include a rotary plate, a horizontal cogwheel, and a horizontal fastening part. The rotary plate may be provided with a horizontal protrusion, and be connected to the operation section to rotate with rotation of the operation section. The horizontal cogwheel may be separated from the rotary plate to be horizontally coupled to a lower end of the clamping section. The horizontal fastening part may engage with cogs of the horizontal cogwheel, and be separated from cogs of the horizontal cogwheel by movement of the horizontal protrusion that arises from rotation of the rotary plate.

The adjustment section of the clamping device according to the embodiment of the present invention may include a rotary plate, a vertical cogwheel, and a vertical fastening part. The rotary plate may be provided with a vertical protrusion, and be connected to the operation section to rotate with rotation of the operation section. The vertical cogwheel may be spaced apart from the rotary plate to be vertically coupled to a lower side surface of the clamping section. The vertical fastening part may engage with cogs of the vertical cogwheel, and be separated from cogs of the vertical cogwheel by the movement of the vertical protrusion that arises from rotation of the rotary plate.

The clamping section of the clamping device according to the embodiment of the present invention may further include a stopper that fixes the holding part. The adjustment section may include a rotary plate, and a stopper connecting part. The rotary plate may be provided with a pulling protrusion, and be connected to the operation section to rotate with rotation of the operation section. The stopper connecting part whose one end is connected to the stopper and the other end is connected to the pulling protrusion may allow the stopper to move by movement of the pulling protrusion that arises from rotation of the rotary plate.

The operation section of the clamping device according to the embodiment of the present invention may include an extension part that is able to be inserted into or drawn from the connection section.

The clamping device according to the embodiment of the present invention may further include a movement casing and a plurality of support sections. The movement casing may surround a lower side of the clamping section, and be able to move up and down. The plurality of support sections may be coupled to the movement casing to support the clamping section. The plurality of support sections may be able to adjust lengths with movement of the movement casing.

The clamping device according to the embodiment of the present invention may further include a driving unit and a control unit. The driving unit may drive the connection section, and the control unit may remotely control the driving unit.

### Effect of the Invention

According to the embodiment of the present invention, since a clamping section is operated by an operation of an operation section, when a handicapped person with a disabled hand or a user other than the handicapped person works with his or her hand, the handicapped person or the user can operate a clamping device by operating the operation section with his or her foot or knee. Accordingly, it is possible to conveniently use the clamping device.

According to the embodiment of the present invention, since the operation section rotates to unlock a part that can adjust an angle and a tilt of the clamping section, it is possible to easily adjust a position of the clamping section.

According to the embodiment of the present invention, it is possible to adjust lengths of a plurality of support sections with a simple operation. Accordingly, the handicapped person with a disabled hand can easily fold and unfold the clamping device, and can carry or store the clamping device with ease.

### DESCRIPTION OF DRAWINGS

FIG. 1 is an exploded perspective view illustrating a clamping device according to an embodiment of the present invention.

FIG. 2 is an exploded view illustrating a clamping section, a connection section, an operation section, and an adjustment section of the clamping device according to the embodiment of the present invention.

FIG. 3 is an exploded view illustrating a coupling relation between the connection section, the clamping section and the adjustment section of the clamping device according to the embodiment of the present invention.

FIG. 4 is a diagram illustrating a configuration for fixing the clamping section of the clamping device according to the embodiment of the present invention.

FIG. 5 is a diagram illustrating support sections and the adjustment section of the clamping device according to the embodiment of the present invention.

FIG. 6 is a diagram illustrating an operation of the adjustment section of the clamping device according to the embodiment of the present invention.

FIGS. 7 and 8 are diagrams that conceptually illustrate the support sections of the clamping device according to the embodiment of the present invention.

### BEST MODE

Hereinafter, preferred embodiments of the present invention will be described in detail with reference to the accompanying drawings. Here, note that the same reference numerals are assigned to the same components in the accompanying drawings. The detailed description of known components and configurations that can obscure the gist of the present invention will not be presented. Likewise, in the accompanying drawings, the components are partially exaggerated, omitted, or schematically illustrated.

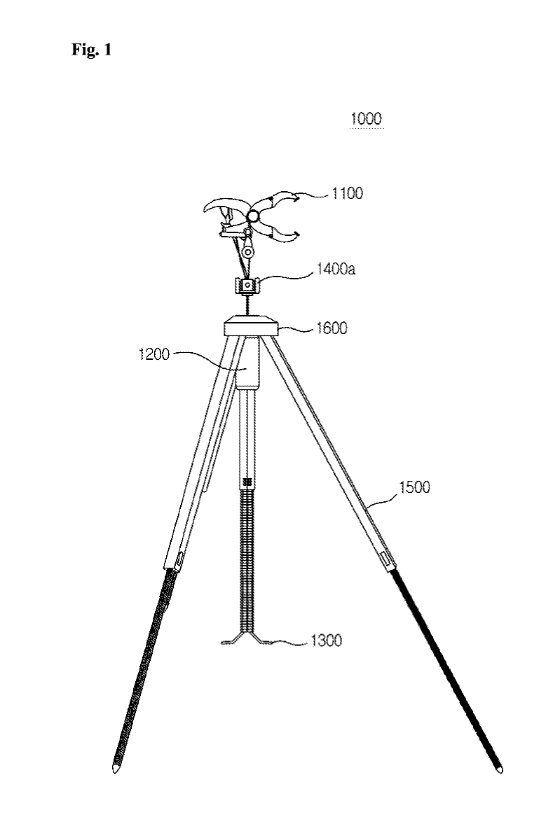

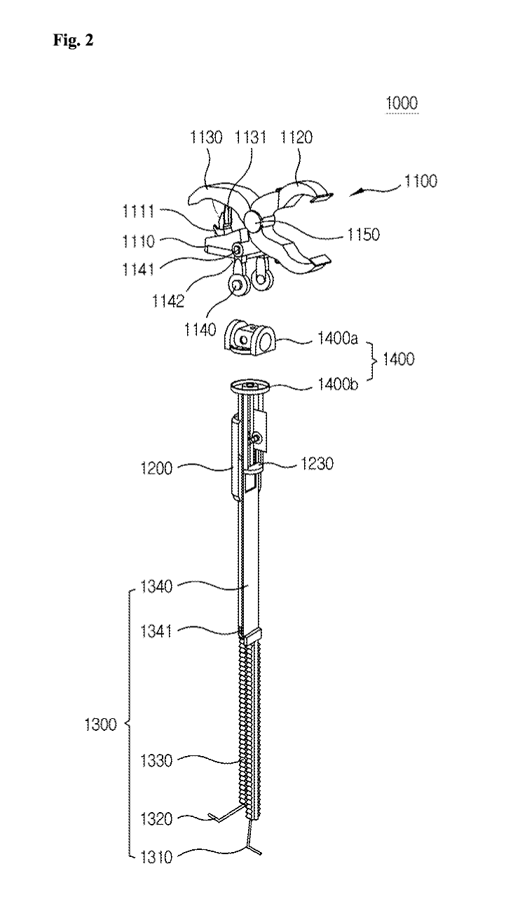

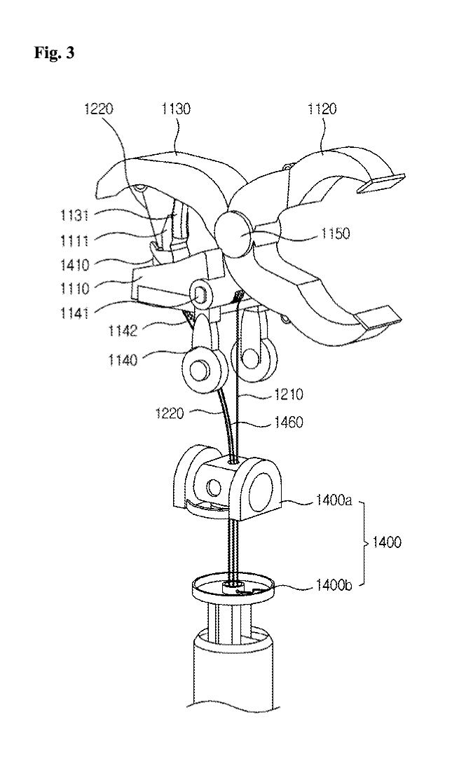

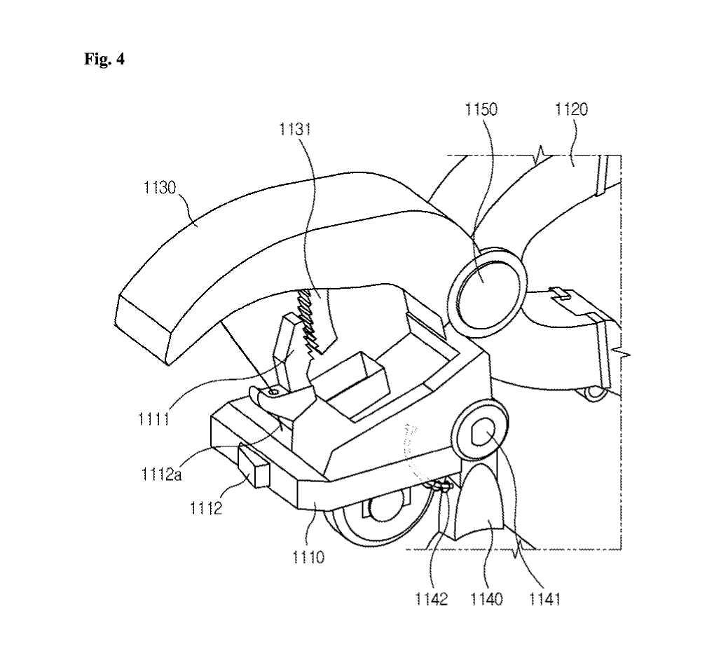

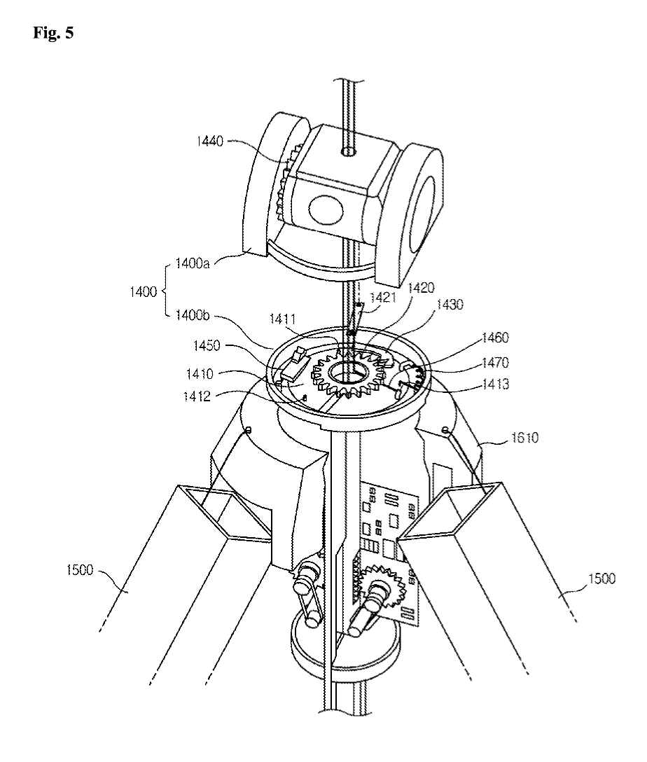

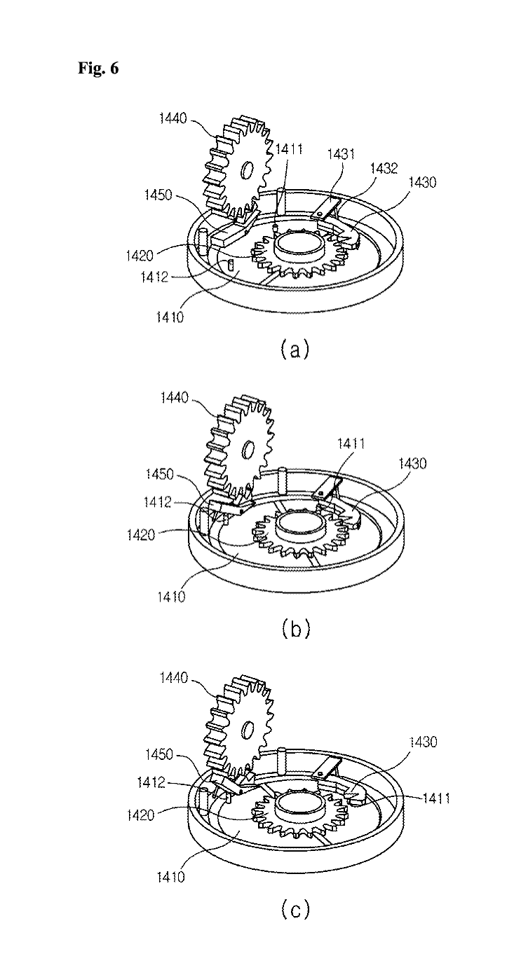

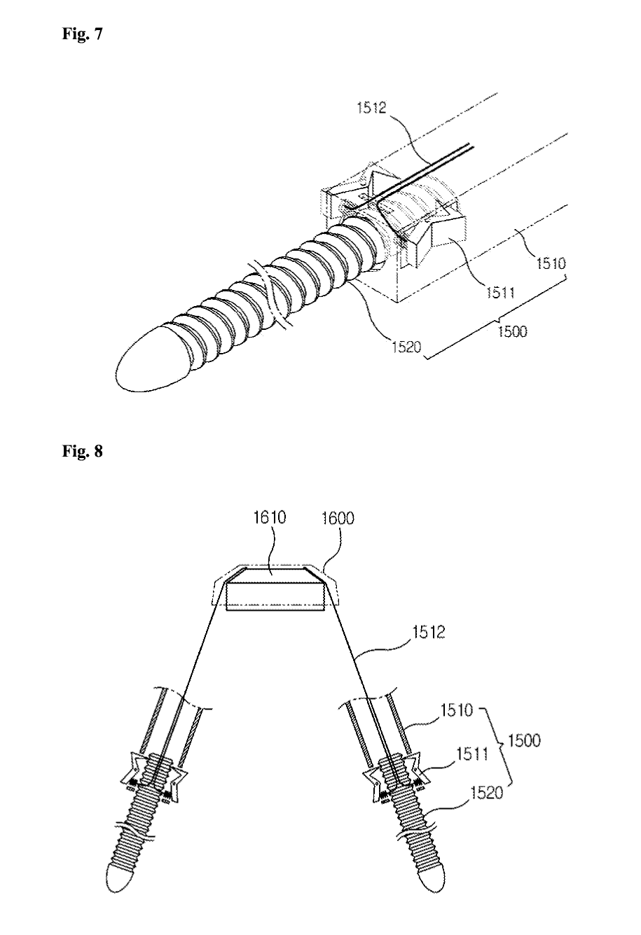

FIG. 1 is an exploded perspective view illustrating a clamping device according to an embodiment of the present invention, FIG. 2 is an exploded view illustrating a clamping section, a connection section, an operation section, and an adjustment section of the clamping device according to the embodiment of the present invention, FIG. 3 is an exploded view illustrating a coupling relation between the connection section, the clamping section and the adjustment section of the clamping device according to the embodiment of the present invention, and FIG. 4 is a diagram illustrating a configuration for fixing the clamping section of the clamping device according to the embodiment of the present invention. FIG. 5 is a diagram illustrating support sections and the adjustment section of the clamping device according to the embodiment of the present invention, and FIG. 6 is a diagram illustrating an operation of the adjustment section of the clamping device according to the embodiment of the present invention. FIGS. 7 and 8 are diagrams that conceptually illustrate the support sections of the clamping device according to the embodiment of the present invention.

As illustrated in FIGS. 1 to 8, a clamping device 1000 according to the embodiment of the present invention includes a clamping section 1100, a connection section 1200, an operation section 1300, an adjustment section 1400, and support sections 1500.

The clamping section 1100 includes a base part 1110, a fixing part 1120, a holding part 1130, and a lower-end coupling part 1140. The base part 1110 is a base of the clamping section 1100. The fixing part 1120 fixes a target object to be fixed. In the present embodiment, the fixing part 1120 has a tongs shape, but the present invention is not limited thereto. The holding part 1130 moves up and down above the base part 1110 to operate the fixing part 1110. That is, the fixing part 1120 is opened or closed with the movement of the holding part 1130. In order to achieve this operation, the fixing part 1120 and the holding part 1130 can be fixed to an end of the base part 1110 by a pin 1150. In the present embodiment, the holding part 1130 is elastically coupled in a direction in which the holding part is spaced apart from the base part 1110 with the pin 1150 as its center. The lower-end coupling part 1140 couples the base part 1110 to the adjustment section 1400. The base part 1110 is rotatably coupled to the lower-end coupling part 1140 through a coupling pin 1141. A locking lever that can fix the rotation of the base part 1110 may be formed at the coupling pin 1141. Further, the lower-end coupling part 1140 includes a horizontal maintaining part 1142 that horizontally maintains the base part 1110. The horizontal maintaining part 1142 may include a guide part and a spring that surrounds the guide part.

The holding part 1130 of the clamping section 1100 may include a latch part 1131 that protrudes downward. Cogs are formed at the latch part 1131. The base part 1110 includes a stopper 1111 for fixing the latch part 1131. The stopper 1111 is movably coupled to the base part 1110. When the stopper 1111 is coupled to the latch part 1131, the holding part 1130 is fixed, and when the stopper 1111 is uncoupled from the latch part 1131, the holding part 1130 can move. A fixing switch 1112 that can fix a position of the stopper 1111 may be formed at the base part 1110. The fixing switch 1112 may be connected to the stopper 1111 by a wire.

The connection section 1200 is connected to the clamping section 1100. In the present embodiment, the connection section 1200 includes a first connection part 1210 and a second connection part 1220. The first connection part 1210 is connected to the coupling pin 1141 of the lower-end coupling part 1140. The second connection part 1220 is connected to the holding part 1130. The connection section 1200 extends toward the ground from below the clamping section 1100, and may include a plurality of ropes.

The operation section 1300 is coupled to a lower end of the connection section 1200. A user moves the operation section 1300 with his or her foot or knee to operate the clamping section 1100. In the present embodiment, the operation section 1300 includes an adjustment footboard 1310 coupled to a lower end of the first connection part 1210, and an operation footboard 1320 coupled to a lower end of the second connection part 1220. The operation section 1300 may include an extension part 1330. The extension part 1330 can be inserted into or drawn from an operation-section case 1340. A locking part 1341 is formed at the operation-section case 1340 to fix the extension part 1330. That is, the extension part 1330 is not inserted into and drawn from the operation-section case when the locking part 1341 is locked, and the extension part 1330 can be inserted into and drawn from the operation-section case when the locking part 1341 is unlocked. The user can position the operation section 1300 at a height corresponding to his or her foot or knee through the extension part 1330.

When the user presses the adjustment footboard 1310 with his or her foot or knee, a movement plate 1230 coupled to the adjustment footboard 1310 moves down, and the first connection part 1210 coupled to the movement plate 1230 also moves down. Thus, the coupling pin 1141 of the lower-end coupling part 1140 coupled to the first connection part 1210 rotates. Accordingly, the base part 1110 that is integrally formed with the coupling pin 1141 rotates, and the entire clamping section 1100 tilts forward. When the user takes his or her foot or knee off the adjustment footboard 1310, the base part 1110 returns to its original position at which the base part is horizontally maintained by the elasticity of the horizontal maintaining part 1142. In this way, the user vertically operates the adjustment footboard 1310 with his or her foot or knee to adjust a back and forth tilt of the clamping section 1100. After adjusting the back and forth tilt of the clamping section, the user can fix the position of the clamping section by using the locking lever formed at the coupling pin 1141.

When the user presses the operation footboard 1320 with his or her foot or knee, the movement plate (not shown) connected to the operation footboard 1320 moves down, and the second connection part 1220 connected to the movement plate also moves down. Thus, the holding part 1130 connected to the second connection part 1220 is pulled down. Accordingly, the fixing part 1120 is closed to fix the target object. In order to fix the position of the fixing part 1120, the user may couple the stopper 1111 to the latch part 1131. The stopper 1111 may be fixed by the fixing switch 1112. The stopper 1111 is automatically coupled to the latch part 1131 by the elasticity of the spring that is basically built therein, and is separated from the latch part 1131 only when the fixing switch 1112 is opened. In order to move the fixing part 1120 again, the fixing switch 1112 is unfixed, and the stopper 1111 is separated from the latch part 1131. When the stopper 1111 and the latch part 1131 are separated from each other, the holding part 1130 moves up by the elasticity acting on the holding part 1130 of the clamping section 1100, and, thus, the fixing part 1120 is opened again. The elasticity acting on the holding part 1130 of the clamping section 1100 is the same as that in a typical clamping device, and, thus, the detailed description thereof will not be presented. When the stopper 1111 and the latch part 1131 are not used, the user simply takes his or her foot or knee off the operation footboard 1320 to return the fixing part 1120 to its original shape. When the user usually takes his or her foot off the operation footboard, the stopper 1111 is continuously fixed to the latch part 1131, and only when the fixing switch 1112 is operated, the stopper is separated from the latch part 1131. In this way, the user vertically operates the operation footboard 1320 with his or her foot or knee to operate the clamping section 1100.

In another embodiment of the present invention, the connection section 1200 can move using a driving unit such as a motor. In this case, a cogwheel interlocked with a belt of the driving unit engages with cogs formed at the connection section 1200 to move the connection section 1200. The driving unit such as a motor may include a voice recognition unit that recognizes voice. Accordingly, the driving unit can operate in response to voice of the user. In this case, the user can remotely operate the clamping device 1000. The driving unit may include a sensor that senses movement of a human body to operate by sensing the movement of the human body. In still another embodiment, the driving unit may be wirelessly adjusted. That is, the driving unit may be remotely controlled, and the user can conveniently use the clamping device 1000.

In order to efficiently use the clamping device 1000, it is necessary to adjust a horizontal angle and a right and left tilt of the clamping section 1100 of the clamping device 1000 in some cases. To achieve this, in the present embodiment, the adjustment section 1400 is located under the clamping section 1110.

The adjustment section 1400 includes an upper case 1400a and a lower case 1400b, and includes a rotary plate 1410, a horizontal cogwheel 1420, a horizontal fastening part 1430, a vertical cogwheel 1440, a vertical fastening part 1450, a stopper connecting part 1460, and an elastic part 1470 within the upper case 1400a and the lower case 1400b.

The rotary plate 1410 is rotatably coupled to the lower case 1400b, and the rotary plate 1410 is connected to the operation section 1300 to rotate with the rotation of the operation section. A horizontal protrusion 1411, a vertical protrusion 1412, and a pulling protrusion 1413 are formed at the rotary plate 1410. In the present embodiment, the vertical protrusion 1412 is located at a position where the vertical protrusion is rotated in a counterclockwise direction from the horizontal protrusion 1411, and the pulling protrusion 1413 is located at a position where the pulling protrusion is further rotated in the counterclockwise direction than the vertical protrusion 1412. However, the positions of the protrusions are not limited to the aforementioned positions.

The horizontal cogwheel 1420 is separated from the rotary plate 1410 to be rotatably and horizontally coupled. A first fixer 1421 is used to fix the horizontal cogwheel 1420. The horizontal fastening part 1430 is attached to the rotary plate 1410 to be spaced apart therefrom in a bar shape. One end of the horizontal fastening part 1430 is rotatably coupled to a second fixer 1431 by a pin, and cogs are formed at the other end thereof to engage with cogs of the horizontal cogwheel 1420. That is, the other end of the horizontal fastening part 1430 rotates around the one end thereof engages with or is separated from the horizontal cogwheel 1420. A guide part that guides the movement of the horizontal protrusion 1411 is formed on a bottom surface of the horizontal fastening part 1430. As shown in FIG. 6, as the rotary plate 1410 rotates, the horizontal protrusion 1411 moves toward below the horizontal fastening part 1430, and moves along the guide part of the horizontal fastening part 1430. The horizontal protrusion 1411 moves along the guide part to move the horizontal fastening part 1430 in a direction in which the horizontal fastening part is separated from the horizontal cogwheel 1420, and, thus, the horizontal cogwheel 1420 can freely rotate. When the horizontal cogwheel 1420 can freely rotate, the user can rotate the clamping section 1100 in a horizontal direction. That is, when the user rotates the operation section 1300 with his or her foot or knee to rotate the rotary plate 1410, the horizontal fastening part 1430 is separated from the horizontal cogwheel 1420 by the rotation of the rotary plate 1410. Since the horizontal cogwheel 1420 can freely rotate, the user can adjust the horizontal angle of the clamping section 1100. In order to prevent the first fixer 1421 from colliding with the vertical fastening part 1450 by the rotation when the horizontal angle of the clamping section 1100 is adjusted, beams are formed on both sides of the vertical cogwheel 1440 as shown in (a) of FIG. 6. When the user takes his or her foot or knee off the operation section 1300, the rotary plate 1410 returns to its original position by the elasticity of the elastic part 1470, and, thus, the horizontal protrusion 1411 returns to its original position. As a result, the horizontal fastening part 1430 engages with the horizontal cogwheel 1420 again by the elasticity of a spring 1432 to fix the horizontal cogwheel 1420.

The vertical cogwheel 1440 is vertically coupled to the upper case 1400a. The vertical fastening part 1450 is fixed to the lower case 1400b by a pin, and can move up and down around the fixed portion. Cogs are formed at the vertical fastening part 1450 to engage with cogs of the vertical cogwheel 1440. That is, the vertical fastening part 1450 rotates around the fixed portion to allow the cogs thereof to engage with the vertical cogwheel 1440 or to be separated therefrom. A curved surface part that guides the movement of the vertical protrusion 1412 is formed on a bottom surface of the vertical fastening part 1450. As shown in FIG. 6, as the rotary plate 1410 rotates, the vertical protrusion 1412 moves toward below the vertical fastening part 1450, and the vertical protrusion 1412 moves along the curved surface part of the vertical fastening part to rotate the vertical fastening part 1450. As a result, the cogs of the vertical fastening part 1450 are separated from the cogs of the vertical cogwheel 1440. Accordingly, the vertical cogwheel 1440 can freely rotate, and the right and left tilt of the clamping section 1100 can be adjusted. That is, the user rotates the operation section 1300 with his or her foot or knee, and can adjust the right and left tilt of the clamping section 1100.

The pulling protrusion 1413 formed at the rotary plate 1410 is connected to the stopper 1111 of the clamping section 1100 through the stopper connecting part 1460. In the present embodiment, the stopper connecting part 1460 is a rope that connects the pulling protrusion 1413 and the stopper 1111, but the present invention is not limited thereto. When the user rotates the operation section 1300 with his or her foot or knee to rotate the rotary plate 1410, the pulling protrusion 1413 also rotates. At this time, the stopper connecting part 1460 connected to the pulling protrusion 1413 is hooked by a rope hooking part, and, thus, the stopper connecting part 1460 is pulled. Accordingly, the stopper 1111 also moves, and the stopper 1111 is disconnected from the latch part 1131 to move the holding part 1130. When the user takes his or her foot or knee off the operation section 1300, the rotary plate 1410 returns to its original position by the elasticity of the elastic part 1470, and the pulling protrusion 1413 also returns to its original position. As a result, the stopper 1111 is also coupled to the latch part 1131. The stopper connecting part 1460 may be positioned by being inserted into a fixation pipe in order to prevent the stopper connecting part from being tangled by the connection section 1200.

In the present embodiment, as shown in FIG. 6, the vertical protrusion 1412 is formed at the position where the vertical protrusion rotates in the counterclockwise direction from the horizontal protrusion 1411, and the pulling protrusion 1413 is formed at the position where the pulling protrusion further rotates in the counterclockwise direction than the vertical protrusion 1412. Accordingly, when the user rotates the operation section 1300 in a clockwise direction by 30 degrees, the vertical protrusion 1412 moves toward below the vertical fastening part 1450, and the vertical fastening part 1450 is separated from the vertical cogwheel 1440. At this time, the horizontal protrusion 1411 also moves toward below the horizontal fastening part 1430, but the horizontal fastening part 1430 is not separated from the horizontal cogwheel 1420. When the user rotates the operation section 1300 in the clockwise direction by 60 degrees, the vertical protrusion 1412 is still positioned below the vertical fastening part 1450, and the horizontal protrusion 1411 moves along a tilt angle from below the horizontal fastening part 1430 to separate the horizontal fastening part 1430 from the horizontal cogwheel 1420. Furthermore, when the user rotates the operation section 1300 in the counterclockwise direction, the horizontal protrusion 1411 and the vertical protrusion 1412 are respectively spaced apart from the horizontal fastening part 1430 and the vertical fastening part 1450, and only the pulling protrusion 1413 pulls the stopper connecting part 1460.

The support sections 1500 support the clamping section 1100 from below the clamping section 1100. More specifically, the support sections 1500 are coupled to a movement casing 1610 located within a casing 1600 surrounding a lower side of the clamping section 1100. As shown in FIG. 5, the movement casing 1610 can move up and down at the outside of the connection section 1200. In the present embodiment, the clamping device 1000 includes the three support sections 1500, but the present invention is not limited thereto. The support section may include an extension rod 1520 and a support 1510 to support the clamping section 1100 and an extension rod 1520. The extension rod 1520 is coupled to the support 1510 so as to be inserted into or drawn from the support 1510.

A screw groove is formed on an outer surface of the extension rod 1520. A support-section stopper 1511 is rotatably coupled within the support 1510 by a pin. One end of the support-section stopper 1511 is formed in a shape capable of coupling to the screw groove formed on the outer surface of the extension rod 1520, and the other end thereof is elastically supported by the support 1510 through a spring. Moreover, the other end of the support-section stopper 1511 is connected to the movement casing 1610 through a connection wire 1512. The connection wire 1512 may be connected to the movement casing 1610 by penetrating through the support 1510. The user pushes up the movement casing 1610 to move the other end of the support-section stopper 1511, and when the other end of the support-section stopper 1511 moves, the support-section stopper 1511 rotates around the pin to allow the one end of the support-section stopper 1511 to be separated from the screw groove formed on the outer surface of the extension rod 1520. Accordingly, the user pulls the extension rod 1520 from the support 1510 or presses the extension rod into the support 1510.

Even though the three support sections 1500 are used, when the connection wires of the respective support sections are connected to the movement casing 1610, the user pushes up the movement casing 1610 to adjust lengths of the three support sections 1500. In addition, the support sections 1500 can be radially unfolded or folded with respect to the movement casing 1610. That is, when the user uses the clamping device 1000, the user can unfold the support sections 1500, and fold the support sections 1500 after the clamping device is used.

Meanwhile, the embodiments of the present invention disclosed in the present specification and drawings are presented by way of example to easily describe the present invention and for better understanding of the present invention, and are not intended to limit the scope of the present invention. It should be apparent to those skilled in the art that in addition to the embodiments disclosed herein, modifications can be implemented without departing from the technical spirit of the present invention.

1. A clamping device comprising:
a clamping section that includes a fixing part configured to a target object, and a holding part configured to operate the fixing part;
a connection section that is connected to the clamping section to extend downward; and
an operation section that is coupled to a lower end of the connection section to operate the clamping section.

2. The clamping device of claim 1, further comprising:
an adjustment section that is coupled to a lower portion of the clamping section, and adjusts a position of the clamping section.

3. The clamping device of claim 2,
wherein the adjustment section includes a rotary plate that is provided with a horizontal protrusion, and is connected to the operation section to rotate with rotation of the operation section, a horizontal cogwheel that is separated from the rotary plate to be horizontally coupled to a lower end of the clamping section, and a horizontal fastening part that engages with cogs of the horizontal cogwheel, and is separated from cogs of the horizontal cogwheel by movement of the horizontal protrusion that arises from rotation of the rotary plate.

4. The clamping device of claim 2,
wherein the adjustment section includes a rotary plate that is provided with a vertical protrusion, and is connected to the operation section to rotate with rotation of the operation section, a vertical cogwheel that is spaced apart from the rotary plate to be vertically coupled to a lower side surface of the clamping section, and a vertical fastening part that engages with cogs of the vertical cogwheel, and is separated from cogs of the vertical cogwheel by the movement of the vertical protrusion that arises from rotation of the rotary plate.

5. The clamping device of claim 2,
wherein the clamping section further includes a stopper that fixes the holding part, and
the adjustment section includes a rotary plate that is provided with a pulling protrusion, and is connected to the operation section to rotate with rotation of the operation section, and a stopper connecting part whose one end is connected to the stopper and the other end is connected to the pulling protrusion to allow the stopper to move by movement of the pulling protrusion that arises from rotation of the rotary plate.

6. The clamping device of claim 1, wherein the operation section includes an extension part that is able to be inserted into or drawn from the connection section.

7. The clamping device of claim 1, further comprising:
a movement casing that surrounds a lower side of the clamping section, and is able to move up and down; and
a plurality of support sections that is coupled to the movement casing to support the clamping section,
wherein the plurality of support sections is able to adjust lengths with movement of the movement casing.

8. The clamping device of claim 1, further comprising:
a driving unit that drives the connection section; and
a control unit that remotely controls the driving unit.

9. The clamping device of claim 3,
wherein the adjustment section includes a rotary plate that is provided with a vertical protrusion, and is connected to the operation section to rotate with rotation of the operation section, a vertical cogwheel that is spaced apart from the rotary plate to be vertically coupled to a lower side surface of the clamping section, and a vertical fastening part that engages with cogs of the vertical cogwheel, and is separated from cogs of the vertical cogwheel by the movement of the vertical protrusion that arises from rotation of the rotary plate.

10. The clamping device of claim 3,
wherein the clamping section further includes a stopper that fixes the holding part, and
the adjustment section includes a rotary plate that is provided with a pulling protrusion, and is connected to the operation section to rotate with rotation of the operation section, and a stopper connecting part whose one end is connected to the stopper and the other end is connected to the pulling protrusion to allow the stopper to move by movement of the pulling protrusion that arises from rotation of the rotary plate.

11. The clamping device of claim 2, wherein the operation section includes an extension part that is able to be inserted into or drawn from the connection section.

12. The clamping device of claim 2, further comprising:
a movement casing that surrounds a lower side of the clamping section, and is able to move up and down; and
a plurality of support sections that is coupled to the movement casing to support the clamping section,
wherein the plurality of support sections is able to adjust lengths with movement of the movement casing.

13. The clamping device of claim 2, further comprising:
a driving unit that drives the connection section; and
a control unit that remotely controls the driving unit.
